(19) United States
(12) Patent Application Publication
(10) Pub. No.: US 2012/0272264 A1
(43) Pub. Date: Oct. 25, 2012

(54) VIDEO SERVER AND STANDBY METHOD

(75) Inventors: Toshio Suzuki, Kawasaki-shi (JP); Takashi Inuduka, Kawasaki-shi (JP)

(73) Assignee: KABUSHIKI KAISHA TOSHIBA, Tokyo (JP)

(21) Appl. No.: 13/358,363

(22) Filed: Jan. 25, 2012

(30) Foreign Application Priority Data
Apr. 20, 2011 (JP) 2011-093898

(51) Int. Cl. H04N 21/231

(52) U.S. Cl. 725/33

(57) ABSTRACT

According to one embodiment, a video server includes a first storage area, a second storage area, and a controller. The controller is configured to control to execute a first standby operation for reading the first content item from the first storage area in accordance with a standby instruction from a host apparatus, to execute a second standby operation for reading the second content item from the second storage area in advance when the first content item is deleted to change the first content item in a state of the first standby operation, to delete the first content item when the second standby operation is complete, and to skip deletion of the first content item when the second standby operation is not complete.

### CROSS-REFERENCE TO RELATED APPLICATIONS

This application is based upon and claims the benefit of priority from prior Japanese Patent Application No. 2011-093898, filed Apr. 20, 2011, the entire contents of which are incorporated herein by reference.

### FIELD

Embodiments described herein relate generally to a video server, which transmits broadcast programs, and a standby method.

### BACKGROUND

A video server for a broadcast station is required to handle large-capacity content items to be broadcast over a large number of channels of terrestrial broadcasting and direct satellite broadcasting. Large-capacity content items result in an increase in time of operations such as recording and deletion of content items in the video server, and operations for the content items have to be executed for the video server until a time immediately before broadcasting. A large number of channels result in an increase in the number of control operations for the video server, and the video server has to have a plurality of control ports and to cope with a plurality of control operations.

On the other hand, the video server has a standby function, which is preparing for the start of broadcasting by decoding the broadcast start positions of about two or three content items next to a content item which is being currently played back, so as to surely playback a content item at the broadcast start time. In such case, a change in content item immediately before broadcasting poses a problem for broadcasting.

The plurality of control operations are simultaneously made for the video server, and a case in which a content item to be scheduled to be broadcast by a certain control port is to be deleted by another control port poses a problem for broadcasting.

### BRIEF DESCRIPTION OF THE DRAWINGS

FIG. 1 is a diagram of an overall system including a video server according an embodiment;

FIG. 2 is a chart showing operations when a content item in a standby state is deleted; and

FIG. 3 is a chart showing operations when a content item is re-recorded.

### DETAILED DESCRIPTION

In general, according to one embodiment, a first storage area in which a first content item to be transmitted in an ordinary state is recorded, a second storage area in which a second content item to be transmitted in an emergency state is recorded in advance, and a controller. The controller is configured to control to execute a first standby operation for reading the first content item from the first storage area in accordance with a standby instruction from a host apparatus, to execute a second standby operation for reading the second content item from the second storage area in advance when the first content item is deleted to change the first content item in a state of the first standby operation, to delete the first content item when the second standby operation is complete, and to skip deletion of the first content item when the second standby operation is not complete.

A video server and standby method according to this embodiment will be described hereinafter with reference to the drawings.

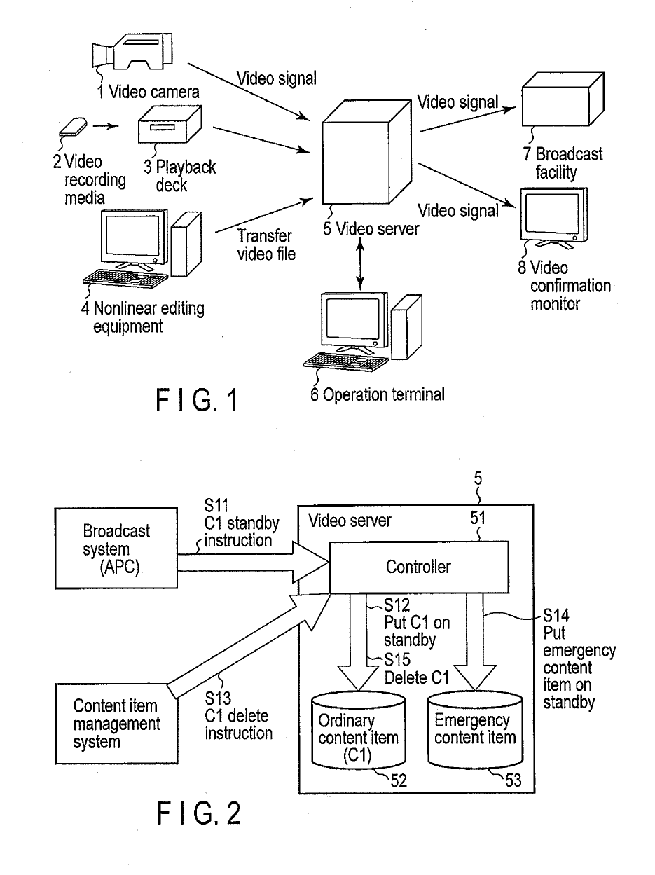

FIG. 1 is a diagram showing an overall system including a video server according to this embodiment. A video server 5 receives a video signal input from a video camera 1 and a playback deck 3 which is used to play back video recording media 2, or receives a video file from a nonlinear editing equipment 4. A video server 5 records the video signal or video file in a storage area of itself as a content item. The video server 5 plays back a recorded content item, and transmits that content item to a broadcast facility 7 and video confirmation monitor 8 as a video signal. These recording operation and playback/transmitting operation are started in response to a control instruction from an operation terminal 6.

Operations of the video server 5 according to this embodiment will be described below by way of respective embodiments.

### First Embodiment

FIG. 2 is a chart showing operations when a content item in a standby state is deleted in the video server 5. The video server 5 includes a controller 51 for executing recording and standby control operations of content items, an ordinary content item storage area 52 in which an ordinary content item (content item C1) to be transmitted in an ordinary state is recorded, and an emergency content item storage area 53 in which an emergency content item to be transmitted in an emergency state is recorded in advance. The ordinary content item storage area 52 and emergency content item storage area 53 may be physically one or a plurality of areas. Note that in the standby state, the broadcast start position of a content item is decoded in advance to prepare for the start of broadcasting.

Upon reception of a standby instruction of the content item C1 to be scheduled to broadcast from a broadcast system such as an automatic program controller (APC) (step S11), the controller 51 of the video server 5 transits to a standby state in which an image at the broadcast start position of the content item C1 is read in advance from the ordinary content item storage area 52 to prepare for the start of broadcasting (step S12).

For example, when the user wants to change this content item C1 in the standby state, a content items management system instructs the video server 5 to delete the ordinary content item C1 (step S13). If the content item C1 is already in the standby state, the controller 51 controls an emergency content item to be put on standby (step S14). If the standby operation of the emergency content item is complete, the controller 51 executes deletion of the content item C1, which is requested to be deleted (step S15). On the other hand, if the standby operation of the emergency content item is not complete, the controller 51 skips deletion of the content item C1.

### Second Embodiment

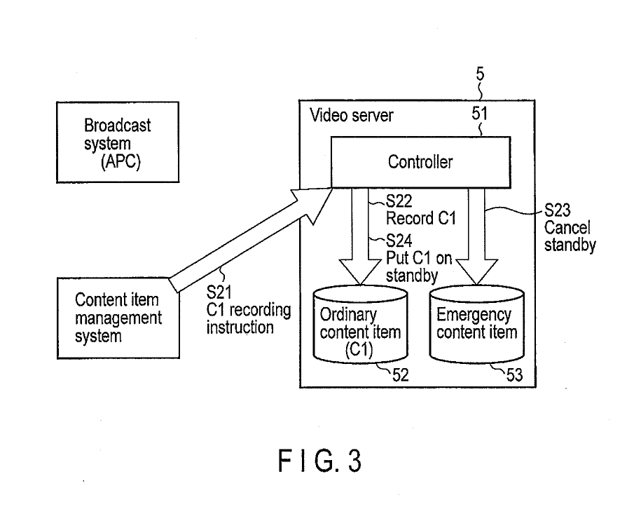

FIG. 3 is a chart showing operations when a content item is re-recorded during a standby operation of an emergency content item in the video server 5.

If the video server 5 is in a standby state of emergency content item by failure of standby operation for the content item C1 since the content item C1 has not been recorded when the controller 51 of the video server 5 receives a standby instruction of the content item C1 from the broadcast system such as the APC, or in the standby state of the emergency content item as in the first embodiment, the content items management system issues a re-recording instruction of the content item C1 to the video server 5 (step S21). The controller 51 executes re-recording of the content item C1 (step S22). If re-recording of the content item C1 until its scheduled standby position is complete, the controller 51 cancels the standby state of the emergency content item (step S23), and controls the content item C1, which is being recorded, to be put on standby again (step S24).

As described above, even when a content item, which is already in a standby state, is deleted, the video server according to this embodiment automatically controls an already recorded emergency content item to be put on standby, so as to prevent broadcasting from being discontinued due to a re-recording failure of the deleted content item. Furthermore, the video server deletes the content item in the standby state, and re-records it. Upon completion of recording until the standby position, the video server automatically executes the standby operation again.

Therefore, the video server according to this embodiment can change a content item immediately before broadcasting without posing any problem for broadcasting.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video server comprising:
a first storage area configured to store a first content item to be transmitted in an ordinary state;
a second storage area configured to store a second content item to be transmitted in an emergency state; and
a controller configured to:
execute a first standby operation for reading the first content item from the first storage area in accordance with a standby instruction from a host apparatus;
execute a second standby operation for reading the second content item from the second storage area in advance when the first content item is to be deleted to change the first content item in a state of the first standby operation;
delete the first content item when the second standby operation is complete; and
skip deletion of the first content item when the second standby operation is not complete.

2. The video server of claim 1, wherein the controller is further configured, when re-recording of the first content item is complete until a standby position in a state of the second standby operation, to cancel the second standby operation and re-execute the first standby operation.

3. A standby method for use in a video server, comprising:
recording a first content item to be transmitted in an ordinary state;
recording in advance a second content item to be transmitted in an emergency state;
executing a first standby operation for reading the first content item in advance in accordance with a standby instruction from a host apparatus; and
controlling, wherein controlling comprises:
executing a second standby operation for reading the second content item in advance when the first content item is to be deleted to change the first content item in a state of the first standby operation,
deleting the first content item when the second standby operation is complete, and
skipping deletion of the first content item when the second standby operation is not complete.

4. The method of claim 3, wherein controlling further comprises, when re-recording of the first content item is complete until a standby position in a state of the second standby operation, canceling the second standby operation, and re-executing the first standby operation.
